(19) United States
(12) Patent Application Publication
(10) Pub. No.: US 2004/0059560 A1
(43) Pub. Date: Mar. 25, 2004

(54) Systems and methods for developing a predictive continuous product space from an existing discrete product space

(76) Inventors: Martha Gardner, Niskayuna, NY (US); Sanjay Mishra, Evansville, IN (US)

Correspondence Address: DOUGHERTY, CLEMENTS & HOFER, 1901 ROXBOROUGH ROAD, SUITE300, CHARLOTTE, NC, 28211, US

(21) Appl. No.: 10/252,152

(22) Filed: Sep. 20, 2002

(51) Int. Cl. G06F 9/45

(52) U.S. Cl. 703/22

(57) ABSTRACT

Systems and methods for developing a predictive continuous product space from an existing discrete product space and using the same, the predictive continuous product space and the existing discrete product space associated with a plurality of commercial or developmental grade engineering thermoplastics, including an engineering thermoplastics product algorithm operable for grouping a plurality of single point product grades into a plurality of product grade families, developing a plurality of predictive models for each of the plurality of product grade families, augmenting each of the plurality of product grade families with additional single point product data to improve modeling capability, and using multiple-response optimization techniques to determine new product grades that meet predetermined performance requirements.

### FIELD OF THE INVENTION

The present invention relates generally to systems and methods for the creation, validation, and development of new products, especially commercial or developmental grade products. More specifically, the present invention relates to systems and methods for using commercial or developmental grade product data to develop transfer functions across a commercial or developmental grade product space for the purpose of rigorously interpolating potential new products.

### BACKGROUND OF THE INVENTION

Often, available commercial or developmental grade products, such as engineering thermoplastics and the like, do not quite meet customer requirements. This is especially true relative to new customers. Typically, a product developer has single point property data related to existing commercial or developmental grade products. When a customer requests a new product, with specific properties, the product developer considers this single point property data and uses a “split-the-difference” approach to create and develop the requested product. In other words, a linear interpolation is performed and any non-linear relationships between the existing commercial or developmental grade products and their properties are not considered. Typically, this process takes place primarily in the product developer's head.

Thus, what is needed are robust systems and methods that allow the product developer to, in a step-by-step manner, turn the single point property data related to existing commercial or developmental grade products into information that may be used to assess the potential suitability and usefulness of the product space between these points. In other words, what is needed are systems and methods that allow the product developer to develop, in an automated manner, a predictive continuous product space from an existing discrete product space. What is also needed are systems and methods that allow the product developer to quickly and easily validate the resulting products, significantly reducing product development cycle time.

### BRIEF SUMMARY OF THE INVENTION

In various embodiments, the systems and methods of the present invention allow a product developer to determine what commercial or developmental grade products may look like “between” existing commercial or developmental grade products. In other words, the systems and methods of the present invention allow the product developer to relate single point property data (both mean and variance) to formulation data and use the resulting information to predict across a continuous product space between the single point property data. Advantageously, the systems and methods of the present invention may significantly speed up engineering delivery of a new commercial or developmental grade product to a customer.

In one embodiment of the present invention, a method for developing a predictive continuous product space from an existing discrete product space, the predictive continuous product space and the existing discrete product space associated with a plurality of commercial grade engineering thermoplastics, includes grouping a plurality of single point product grades into a plurality of product grade families, developing a plurality of predictive models for each of the plurality of product grade families, and augmenting each of the plurality of product grade families with a plurality of additional single point product grades to improve modeling capability.

In another embodiment of the present invention, a system for developing a predictive continuous product space from an existing discrete product space, the predictive continuous product space and the existing discrete product space associated with a plurality of commercial grade engineering thermoplastics, includes an engineering thermoplastics algorithm operable for grouping a plurality of single point product grades into a plurality of product grade families, developing a plurality of predictive models for each of the plurality of product grade families, and augmenting each of the plurality of product grade families with a plurality of additional single point product grades to improve modeling capability.

### BRIEF DESCRIPTION OF THE DRAWINGS

The systems and methods of the present invention are described herein below with reference to various drawings and graphical representations thereof, in which:

FIG. 1 is a flow chart of one embodiment of a method for developing a predictive continuous product space from an existing discrete product space of the present invention;

FIG. 2 is a flow chart of another embodiment of the method for developing a predictive continuous product space from an existing discrete product space of the present invention, highlighting the grouping of a plurality of single point grades into a plurality of grade families;

FIG. 3 is a flow chart of a further embodiment of the method for developing a predictive continuous product space from an existing discrete product space of the present invention, highlighting the development of a plurality of predictive models for each of the plurality of grade families;

FIG. 4 is a flow chart of a still further embodiment of the method for developing a predictive continuous product space from an existing discrete product space of the present invention, highlighting the augmentation of each of the plurality of grade families with a plurality of additional single point grades to improve modeling capability; and

FIG. 5 is a schematic diagram of one embodiment of a system for developing a predictive continuous product space from an existing discrete product space of the present invention.

### DETAILED DESCRIPTION OF THE INVENTION

As described above, the systems and methods of the present invention allow a product developer to determine what commercial or developmental grade products may look like “between” existing commercial or developmental grade products. In other words, the systems and methods of the present invention allow the product developer to relate single point property data (both mean and variance) to formulation data and use the resulting information to predict across a continuous product space between the single point property data. Advantageously, the systems and methods of the present invention may significantly speed up engineering delivery of a new commercial or developmental grade product, such as an engineering thermoplastic or the like, to a customer.

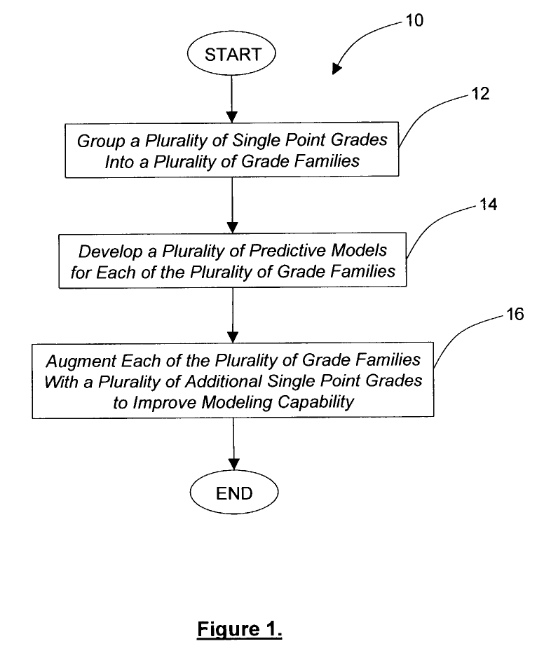

Referring to FIG. 1, in one embodiment of the present invention, a method 10 for developing a predictive continuous product space from an existing discrete product space includes three (3) primary steps: grouping a plurality of single point grades into a plurality of grade families 12, developing a plurality of predictive models for each of the plurality of grade families 14, and augmenting each of the plurality of grade families with a plurality of additional single point grades to improve modeling capability 16.

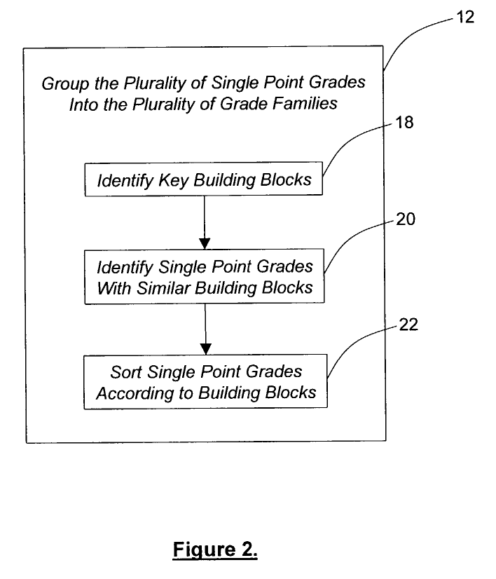

Referring to FIG. 2, in another embodiment of the present invention, grouping the plurality of single point grades into the plurality of grade families 12 includes three (3) secondary steps: identifying key building blocks 18, identifying single point grades with similar building blocks 20, and sorting single point grades according to the building blocks 22.

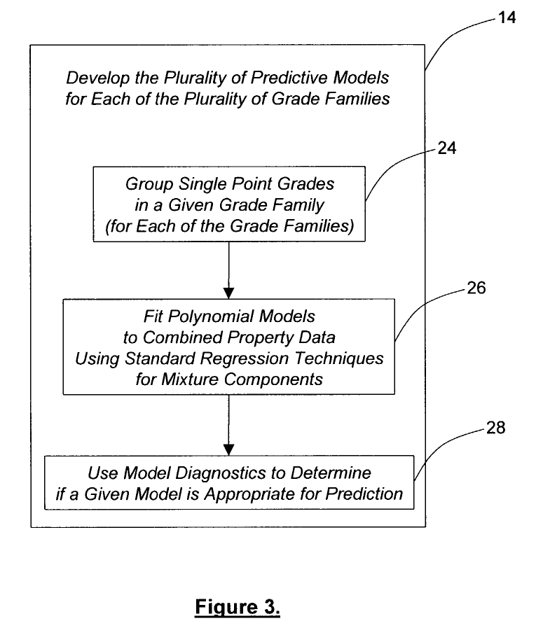

Referring to FIG. 3, in a further embodiment of the present invention, developing the plurality of predictive models for each of the plurality of grade families 14 includes three (3) secondary steps: grouping single point grades in a given grade family (for each of the grade families) 24; fitting statistical models, typically Scheffe polynomial models that account for sum total constraint and individual constraints on formulation components, to relate property data to formulation component factors 26; and using model diagnostics to determine if a given model is appropriate for prediction 28.

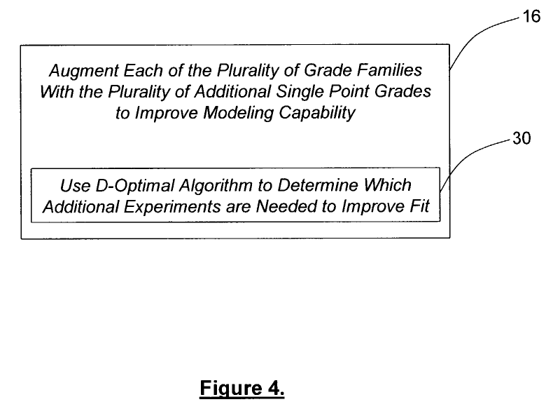

Referring to FIG. 4, in a still further embodiment of the present invention, augmenting each of the plurality of grade families with the plurality of additional single point grades to improve modeling capability 16 includes one (1) secondary step: using a D-optimal algorithm to determine which additional experiments are needed to improve fit 30.

Each of these primary and secondary steps are described in greater detail herein below.

The main assumption made in relation to the systems and methods of the present invention is that the key building blocks of a commercial or developmental grade product, rather than any additives, have the strongest effect on its “critical to quality” (“CTQ”) aspects. Thus, grouping single point grades into grade families revolves around selecting single point grades that have matching building blocks which each make up about 5% or more of the formulation of each single point grade. For example, polycarbonate (“PC”) blends with polybutylene terephthalate (“PBT”) and a specific impact modifier may be grouped together. Preferably, each component of each single point grade is scaled to the percentage of the total of the building blocks and is rounded to two (2) decimal places. Following decimal place adjustment, the sums of the percentages should be 100. This is illustrated in Tables 1 and 2.

TABLE 1
Original Formulations

| | Building | Building | Building | Building | | | | |
|---|---|---|---|---|---|---|---|---|
| Grade | Block A | Block B | Block C | Block D | Additive E | Additive F | Additive G | Sum |
| 1 | 45.00 | 15.00 | 20.00 | 19.00 | 0.95 | | 0.05 | 100 |
| 2 | 37.50 | 27.50 | 15.00 | 19.35 | 0.55 | 0.10 | | 100 |
| 3 | 20.00 | 34.90 | 24.25 | 20.00 | 0.55 | 0.10 | | 100 |
| 4 | 45.00 | 15.00 | 24.00 | 15.00 | 0.95 | | 0.05 | 100 |
| 5 | 25.00 | 34.00 | 25.00 | 15.00 | 0.95 | | 0.05 | 100 |
| 6 | 39.25 | 19.25 | 22.75 | 17.75 | 0.95 | | 0.05 | 100 |
| 7 | 37.40 | 27.25 | 25.00 | 10.00 | 0.55 | 0.10 | | 100 |
| 8 | 44.35 | 25.00 | 20.00 | 10.00 | 0.55 | 0.10 | | 100 |
| 9 | 30.00 | 24.00 | 25.00 | 20.00 | 0.95 | | 0.05 | 100 |
| 10 | 44.00 | 25.00 | 15.00 | 15.00 | 0.95 | | 0.05 | 100 |
| 11 | 30.00 | 34.35 | 15.00 | 20.00 | 0.55 | 0.10 | | 100 |
| 12 | 40.00 | 34.35 | 15.00 | 10.00 | 0.55 | 0.10 | | 100 |
| 13 | 30.00 | 35.00 | 24.00 | 10.00 | 0.95 | | 0.05 | 100 |
| 14 | 30.00 | 35.00 | 20.00 | 14.00 | 0.95 | | 0.05 | 100 |

TABLE 2
Scaled Building Blocks

| Grade | BB-A | BB-B | BB-C | BB-D | Sum |
|---|---|---|---|---|---|
| 1 | 45.45 | 15.15 | 20.20 | 19.20 | 100 |
| 2 | 37.75 | 27.67 | 15.10 | 19.48 | 100 |
| 3 | 20.17 | 35.20 | 24.46 | 20.17 | 100 |
| 4 | 45.45 | 15.15 | 24.25 | 15.15 | 100 |
| 5 | 25.25 | 34.35 | 25.25 | 15.15 | 100 |
| 6 | 39.65 | 19.44 | 22.98 | 17.93 | 100 |
| 7 | 37.53 | 27.34 | 25.09 | 10.04 | 100 |
| 8 | 44.64 | 25.16 | 20.13 | 10.07 | 100 |
| 9 | 30.30 | 24.25 | 25.25 | 20.20 | 100 |
| 10 | 44.45 | 25.25 | 15.15 | 15.15 | 100 |
| 11 | 30.20 | 34.57 | 15.10 | 20.13 | 100 |
| 12 | 40.26 | 34.57 | 15.10 | 10.07 | 100 |
| 13 | 30.30 | 35.35 | 24.25 | 10.10 | 100 |
| 14 | 30.30 | 35.35 | 20.20 | 14.15 | 100 |
| Min | 20.17 | 15.15 | 15.10 | 10.04 | — |
| Max | 45.45 | 35.35 | 25.25 | 20.20 | — |

If there are n building blocks (in the example above, n=4) with varying levels across the product space, there should be at least n+4 grades in order to begin an assessment. In the example above, there are fourteen (14) grades, so this requirement is met. This allows a linear transfer function to be fit with four (4) lack of fit points. Because there are no “replicates” in the commercial or developmental grade product space dealt with herein, these lack of fit points are used as the residual error. Preferably, there are [n!/(2(n−2)!)]+4 grades, allowing all linear and quadratic Scheffe model terms plus four (4) lack of fit points for the residual error. In the example above (for n=4), this calculation yields ten (10) grades which indicates that linear as well as quadratic Scheffe models may be considered, as the data set includes fourteen (14) grades. Preferably, all product formulation and CTQ information for each product within a family is collected together.

In practice, using software such as Design-Expert 6, the first step is to create a file that contains the exact number of columns (components) and rows (grades) that are to be imported. Using the example above, there are four (4) formulation components and fourteen (14) grades. Assuming three (3) CTQ responses, a Design-Expert 6 file is created using the following four (4) steps: beginning a new D-optimal mixture design with the number of components equal to the number of varying building blocks and a total of about 100%, selecting the total number of points to match the total number of grades being imported, inputting the names of the CTQ aspects, and clicking on “continue” until a design is produced (in the example above, there are fourteen (14) runs). It should be noted that the initial D-optimal design generated by the software should not be used in subsequent analyses as it may differ from the actual formulation of the commercial product grades. The scaled building block formulations of the fourteen (14) grades are then copied and pasted on top of the fourteen (14) runs produced by Design-Expert 6. It should be noted that other formulation component-related factors may be included that are discrete (rather than continuous); for example, impact modifier type may be included as a factor. The procedure described above would be followed using a crossed mixture-non-mixture base design.

Finally, the CTQ information is copied and pasted, making sure that the formulation information and the CTQ information are matched up correctly. The CTQ information may include both mean and variance for a CTQ where numbers may come from a plurality of possible sources, such as data sheet information or in-house production/quality testing data.

In evaluating grade space coverage, the first step is to determine which effects may be estimated based upon the formulation information that has been inputted. To do this using the evaluation tool, begin with at least a quadratic mixture model (if there are at least [n!/(2(n−2)!)]+4 grades), or a linear mixture model if there are no more than n+4 grades. If the number of grades is somewhere in between, iterations may be performed using the evaluation tool in order to determine which two-way non-linear blending effects may be estimated. In the example above, there are fourteen (14) grades, so the quadratic mixture model is the base model and the following evaluation results are obtained (illustrated in Tables 3, 4, and 5).

TABLE 3
Degrees of Freedom for Evaluation

| | |
|---|---|
| Model | 9 |
| Residuals | 4 |
| Lack of Fit | 4 |
| Pure Error | 0 |
| Corr. Total | 13 |

TABLE 4
Standard Error for Term Effects

| Term | StdErr** |
|---|---|
| A | 3.33 |
| B | 5.49 |
| C | 36.48 |
| D | 31.61 |
| AB | 12.33 |
| AC | 50.20 |
| AD | 41.80 |
| BC | 52.35 |
| BD | 46.90 |
| CD | 69.47 |

**Basis Std. Dev. = 1.0

TABLE 5
Measures Derived From the (X′X)⁻¹ Matrix

| Std. | Leverage |
|---|---|
| 1 | 0.9340 |
| 2 | 0.7195 |
| 3 | 0.7864 |
| 4 | 0.7625 |
| 5 | 0.6642 |
| 6 | 0.7844 |
| 7 | 0.4924 |
| 8 | 0.8284 |
| 9 | 0.5944 |
| 10 | 0.5473 |
| 11 | 0.8538 |
| 12 | 0.7921 |
| 13 | 0.3883 |
| 14 | 0.8526 |

Average = 0.7143

In the example above, the maximum prediction variance (at a design point) was found to be 0.934, the average prediction variance was found to be 0.714, the condition number of the coefficient matrix was found to be 6032.56, the G-efficiency (calculated from the design points) was found to be 76.5%, and the scaled D-optimality criterion was found to be 806.837.

There are two “flags” that may be observed. First, if any leverages are equal to 1, replicating this point is not an option as commercial grade information is being used. In such a case, the order of the model may be reduced and the resulting leverages observed. Alternatively, an extreme grade may be removed from the family if it is determined that the point is so extreme (in terms of its location in the formulation space) that it may not really belong to the same family as the other points. Second, if the correlation matrix of regression coefficients shows any −1 or 1 correlations, or if any of the standard errors of the coefficients are orders of magnitude larger than the others, the order of the model may be reduced and the evaluation diagnostics re-calculated and assessed. It should also be observed where the grades fall throughout the grade space using ternary plots (or slices of ternary plots in the case of more than three (3) formulation components), well known to those of ordinary skill in the art.

If there are any effects that are not estimable, then the existing information may be augmented with additional formulations and CTQ data. One possible way to select additional formulations for inclusion is to use a D-optimal algorithm where the desired effect is pre-selected. The result is the formulation(s) in the core space that need to be made and tested to be able to estimate the desired effect. The D-optimal algorithm is typically used to select design points in a mixture-constrained setup.

Once the evaluation is completed and any augmentation has been done, statistical models may be fit to the data. In developing and using transfer functions across the commercial or developmental grade product space, a product developer should begin with the highest order model that the evaluation will support and reduce the model until only significant terms are left. For example, alpha=0.05 may be used as a critical value to start. This process is commonly known as “backward regression” and is considered a robust technique in the face of the colinearity introduced by the total constraint amongst the mixture components. Throughout the process, full examination of the numerical results, as well as the diagnostic plots, are needed. The product developer should examine how the adjusted r-square and predicted r-square values compare with the regular r-square, and look for a straight line on the normal probability plot of the residuals and random scatter on the residuals vs. predicted values plot. The product developer may also look to see if any outliers or high leverage points are flagged on their respective plots. A Box-Cox plot may also be used to assess the need for transformation of the response data. Once the appropriate transfer functions have been developed, multiple-response optimization techniques, both numerical and graphical, may be used to determine optimal formulations that meet customer requirements and are inside the commercial or developmental grade product space but are not yet commercial formulations. Validation studies of these formulations are suggested before scaling up in manufacturing.

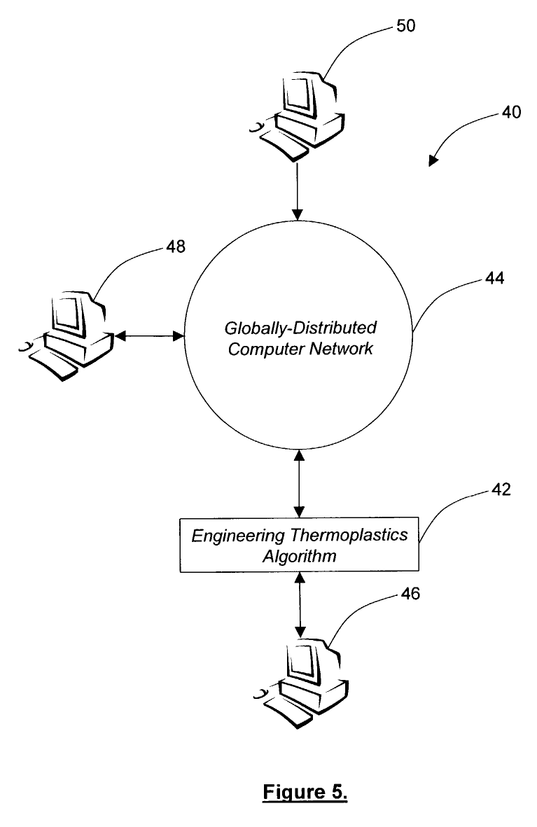

Referring to FIG. 5, in one embodiment of the present invention, a system 40 for developing a predictive continuous product space from an existing discrete product space includes the engineering thermoplastics product algorithm 42 described above. The engineering thermoplastics product algorithm 42 is in communication with a plurality of user (customer and/or product developer) computers 46,48,50 via a plurality of direct connections and/or a globally-distributed computer network 44, such as the Internet or an intranet (local-area network (LAN)/wide-area network (WAN)). Preferably, a plurality of users (customers and/or product developers) may interact with the engineering thermoplastics product algorithm via one or more web pages or the like.

It should be noted that what has been described herein as an “engineering thermoplastic” may include, but is not limited to, a thermoplastic resin that is capable of being formed by injection molding, press molding, and the like, allowing for high productivity. The thermoplastic resin may include, for example, polyesters, such as polyethylene terephthalate (PET), polybutylene terephthalate (PBT), polyethylene naphthalate (PEN), liquid crystal polyester (LCP), and the like; polyolefins, such as polyethylene (PE), polypropylene (PP), polybutylene, and the like; styrene-type resins, etc.; and polyoxymethylene (POM), polyamide (PA), polycarbonate (PC), polymethylene methacrylate (PMMA), polyvinyl chloride (PVC), polyphenylene sulfide (PPS), polyphenylene ether (PPE), polyimide (PI), polyamide imide (PAI), polyetherimide (PEI), polysulfone (PSU), polyether sulphone (PES), polyketone (PK), polyether ketone (PEK), polyether ether ketone (PEEK), polyalylate (PAR), polyethernitrile (PEN), phenol resins (novolac type and the like), phenoxy resins, fluorocarbon resins, and, furthermore, thermoplastic elastomers of a polystyrene type, a polyolefin type, a polyurethane type, a polyester type, a polyamide type, a polybutadiene type, polyisoprene type, a fluorine type, and the like, and copolymers or modifications of any of the substances described above, and blended resins of two or more of the substances described above, and the like. Furthermore, in order to improve the impact strength of the substances described above, resins obtained by adding an elastomer or a rubber component into the resins may also be used. The engineering thermoplastics of the present invention may further contain one or more reinforcing agents including, but not limited to, glass, talc, mica, clay, or combinations thereof; flame retarding compounds used alone or in combination with a synergist; drip retarding agents; and a wide variety of other additives, such as stabilizers, pigments, colorants, processing aides, andtioxidants, and the like. Preferably, the engineering thermoplastic is selected from the group consisting of styrene-type resins, polycarbonate resins, polyphenylene ether resins, polyamide resins, polyester resins, polyphenylene sulfide resins, polyolebi resins, liquid-crystalline resins, and phenol-type resins. The systems and methods of the present invention may also be used in conjunction with other materials, such as glasses, ceramics, metals, etc.

It is apparent that there has been provided, in accordance with the systems and methods of the present invention, an algorithm for developing a predictive continuous product space from an existing discrete product space. Although the systems and methods of the present invention have been described with reference to preferred embodiments and examples thereof, other embodiments and examples may perform similar functions and/or achieve similar results. Any and all such equivalent embodiments and examples fall within the spirit and scope of the present invention and are intended to be covered by the following claims.

What is claimed is:

1. A method for developing a predictive continuous product space from an existing discrete product space and using the same, the method comprising:
grouping a plurality of single point product grades into a plurality of product grade families;
developing a plurality of predictive models for each of the plurality of product grade families;
augmenting each of the plurality of product grade families with additional single point product data to improve modeling capability; and
using multiple-response optimization techniques to determine new product grades that meet predetermined performance requirements.

2. The method of claim 1, wherein grouping the plurality of single point product grades into the plurality of product grade families comprises identifying a plurality of key building blocks associated with each of the plurality of single point product grades.

3. The method of claim 2, wherein grouping the plurality of single point product grades into the plurality of product grade families further comprises identifying single point product grades with similar key building blocks.

4. The method of claim 3, wherein grouping the plurality of single point product grades into the plurality of product grade families further comprises sorting the plurality of single point product grades according to the plurality of key building blocks.

5. The method of claim 1, wherein developing the plurality of predictive models for each of the plurality of product grade families comprises grouping the plurality of single point product grades in a given product grade family for each of the plurality of product grade families.

6. The method of claim 5, wherein developing the plurality of predictive models for each of the plurality of product grade families further comprises fitting a Scheffe polynomial model that accounts for sum total constraint and individual constraints on formulation components to relate mean and/or variance property data to continuous and/or discrete formulation component factors.

7. The method of claim 6, wherein developing the plurality of predictive models for each of the plurality of product grade families further comprises using multiple numerical and graphical model diagnostics to determine if a given model is appropriate for prediction.

8. The method of claim 1, wherein augmenting each of the plurality of product grade families with additional single point product data to improve modeling capability comprises using a D-optimal algorithm to determine which additional experiments are needed to improve fit.

9. The method of claim 1, wherein the existing discrete product space comprises an existing discrete commercial or developmental grade product space.

10. The method of claim 1, wherein the predictive continuous product space comprises a predictive continuous commercial or developmental grade product space.

11. The method of claim 1, wherein the product comprises a commercial grade engineering thermoplastic.

12. A method for developing a predictive continuous product space from an existing discrete product space and using the same, the predictive continuous product space and the existing discrete product space associated with a plurality of commercial grade engineering thermoplastics, the method comprising:
grouping a plurality of single point product grades into a plurality of product grade families;
developing a plurality of predictive models for each of the plurality of product grade families;
augmenting each of the plurality of product grade families with additional single point product data to improve modeling capability; and
using multiple-response optimization techniques to determine new product grades that meet predetermined performance requirements.

13. The method of claim 12, wherein grouping the plurality of single point product grades into the plurality of product grade families comprises identifying a plurality of key building blocks associated with each of the plurality of single point product grades.

14. The method of claim 13, wherein grouping the plurality of single point product grades into the plurality of product grade families further comprises identifying single point product grades with similar key building blocks.

15. The method of claim 14, wherein grouping the plurality of single point product grades into the plurality of product grade families further comprises sorting the plurality of single point product grades according to the plurality of key building blocks.

16. The method of claim 12, wherein developing the plurality of predictive models for each of the plurality of product grade families comprises grouping the plurality of single point product grades in a given product grade family for each of the plurality of product grade families.

17. The method of claim 16, wherein developing the plurality of predictive models for each of the plurality of product grade families further comprises fitting a Scheffe polynomial model that accounts for sum total constraint and individual constraints on formulation components to relate mean and/or variance property data to continuous and/or discrete formulation component factors.

18. The method of claim 17, wherein developing the plurality of predictive models for each of the plurality of product grade families further comprises using multiple numerical and graphical model diagnostics to determine if a given model is appropriate for prediction.

19. The method of claim 12, wherein augmenting each of the plurality of product grade families with additional single point product data to improve modeling capability comprises using a D-optimal algorithm to determine which additional experiments are needed to improve fit.

20. A system for developing a predictive continuous product space from an existing discrete product space and using the same, the system comprising:
a product algorithm operable for:
grouping a plurality of single point product grades into a plurality of product grade families;
developing a plurality of predictive models for each of the plurality of product grade families;
augmenting each of the plurality of product grade families with additional single point product data to improve modeling capability; and
using multiple-response optimization techniques to determine new product grades that meet predetermined performance requirements.

21. The system of claim 20, wherein the product algorithm is further operable for identifying a plurality of key building blocks associated with each of the plurality of single point product grades.

22. The system of claim 21, wherein the product algorithm is further operable for identifying single point product grades with similar key building blocks.

23. The system of claim 22, wherein the product algorithm is further operable for sorting the plurality of single point product grades according to the plurality of key building blocks.

24. The system of claim 20, wherein the product algorithm is further operable for grouping the plurality of single point product grades in a given product grade family for each of the plurality of product grade families.

25. The system of claim 24, wherein the product algorithm is further operable for fitting a Scheffe polynomial model that accounts for sum total constraint and individual constraints on formulation components to relate mean and/or variance property data to continuous and/or discrete formulation component factors.

26. The system of claim 25, wherein the product algorithm is further operable for using multiple numerical and graphical model diagnostics to determine if a given model is appropriate for prediction.

27. The system of claim 20, wherein the product algorithm is further operable for using a D-optimal algorithm to determine which additional experiments are needed to improve fit.

28. The system of claim 20, wherein the existing discrete product space comprises an existing discrete commercial or developmental grade product space.

29. The system of claim 20, wherein the predictive continuous product space comprises a predictive continuous commercial or developmental grade product space.

30. The system of claim 20, wherein the product comprises a commercial or developmental grade engineering thermoplastic.

31. A system for developing a predictive continuous product space from an existing discrete product space and using the same, the predictive continuous product space and the existing discrete product space associated with a plurality of commercial grade engineering thermoplastics, the system comprising:
an engineering thermoplastics product algorithm operable for:
grouping a plurality of single point product grades into a plurality of product grade families;
developing a plurality of predictive models for each of the plurality of product grade families;
augmenting each of the plurality of product grade families with additional single point product data to improve modeling capability; and
using multiple-response optimization techniques to determine new product grades that meet predetermined performance requirements.

32. The system of claim 31, wherein the engineering thermoplastics product algorithm is further operable for identifying a plurality of key building blocks associated with each of the plurality of single point product grades.

33. The system of claim 32, wherein the engineering thermoplastics product algorithm is further operable for identifying single point product grades with similar key building blocks.

34. The system of claim 33, wherein the engineering thermoplastics product algorithm is further operable for sorting the plurality of single point product grades according to the plurality of key building blocks.

35. The system of claim 31, wherein the engineering thermoplastics product algorithm is further operable for grouping the plurality of single point product grades in a given product grade family for each of the plurality of product grade families.

36. The system of claim 35, wherein the engineering thermoplastics product algorithm is further operable for fitting a Scheffe polynomial model that accounts for sum total constraint and individual constraints on formulation components to relate mean and/or variance property data to continuous and/or discrete formulation component factors.

37. The system of claim 36, wherein the engineering thermoplastics product algorithm is further operable for using multiple numerical and graphical model diagnostics to determine if a given model is appropriate for prediction.

38. The system of claim 31, wherein the engineering thermoplastics product algorithm is further operable for using a D-optimal algorithm to determine which additional experiments are needed to improve fit.

39. A product formulated by the process, comprising:
grouping a plurality of single point product grades into a plurality of product grade families;
developing a plurality of predictive models for each of the plurality of product grade families;
augmenting each of the plurality of product grade families with additional single point product data to improve modeling capability; and
using multiple-response optimization techniques to determine new product grades that meet predetermined performance requirements.

40. The product of claim 39, wherein grouping the plurality of single point product grades into the plurality of product grade families comprises identifying a plurality of key building blocks associated with each of the plurality of single point product grades.

41. The product of claim 40, wherein grouping the plurality of single point product grades into the plurality of product grade families further comprises identifying single point product grades with similar key building blocks.

42. The product of claim 41, wherein grouping the plurality of single point product grades into the plurality of product grade families further comprises sorting the plurality of single point product grades according to the plurality of key building blocks.

43. The product of claim 39, wherein developing the plurality of predictive models for each of the plurality of product grade families comprises grouping the plurality of single point product grades in a given product grade family for each of the plurality of product grade families.

44. The product of claim 43, wherein developing the plurality of predictive models for each of the plurality of product grade families further comprises fitting a Scheffe polynomial model that accounts for sum total constraint and individual constraints on formulation components to relate mean and/or variance property data to continuous and/or discrete formulation component factors.

45. The product of claim 44, wherein developing the plurality of predictive models for each of the plurality of product grade families further comprises using multiple numerical and graphical model diagnostics to determine if a given model is appropriate for prediction.

46. The product of claim 39, wherein augmenting each of the plurality of product grade families with additional single point product data to improve modeling capability comprises using a D-optimal algorithm to determine which additional experiments are needed to improve fit.

47. The product of claim 39, wherein the existing discrete product space comprises an existing discrete commercial or developmental grade product space.

48. The product of claim 39, wherein the predictive continuous product space comprises a predictive continuous commercial or developmental grade product space.

49. The product of claim 39, wherein the product comprises a commercial or developmental grade engineering thermoplastic.
